(19) United States
(12) Patent Application Publication
(10) Pub. No.: US 2022/0327256 A1
(43) Pub. Date: Oct. 13, 2022

(54) SYSTEMS AND METHODS FOR HYBRID PROGNOSTICS

(71) Applicant: Sentient Science Corporation, Buffalo, NY (US)

(72) Inventors: Nathan Bolander, Idaho Falls, ID (US); Andrew Vechart, Minnetrista, MN (US)

(21) Appl. No.: 17/658,297

(22) Filed: Apr. 7, 2022

Related U.S. Application Data
(60) Provisional application No. 63/171,801, filed on Apr. 7, 2021.

(51) Int. Cl. G06F 30/15; G06F 30/27; G07C 5/08; G07C 5/00

(52) U.S. Cl. CPC G06F 30/15; G06F 30/27; G07C 5/0841; G07C 5/008; G07C 5/0808; G06F 2119/02

(57) ABSTRACT

A system for determining a health state of a component includes a processor and a non-transitory computer-readable storage medium that stores a plurality of computer-executable instructions thereon. The processor, in response to executing the plurality of computer-readable instructions, may be configured to perform one or more steps. The steps may include obtaining, from a first data source, usage data for the component; obtaining, from a second data source, a condition indicator for the component; running a usage model to produce usage parameters for the component based on the usage data; running a damage model to produce a damage estimate for the component based on the usage parameters; and running a prediction model to produce a health state estimate of the component based on the damage estimate and the condition indicator.

### CROSS-REFERENCES TO RELATED APPLICATIONS

This nonprovisional patent application claims priority to U.S. Provisional Patent Application No. 63/171,801, entitled “SYSTEMS AND METHODS FOR HYBRID PROGNOSTICS,” filed on Apr. 7, 2021, which is pending, and which is incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE DISCLOSURE

The present disclosure generally relates to machine components, and more particularly to systems and methods for hybrid prognostics.

An operator of a machine or apparatus may desire to determine a health state of a component of that machine or apparatus in order to know whether to repair or replace the component. This is difficult for several reasons. First, some degradation of the component may occur internally and may not be visible. Second, the operational history of the component may be sparse or may not be available at all. With very little information about the component, determining its current health state or a future health state is difficult.

Conventional systems for determining the health state of a component often include using data about the current state of the component with predictive models to output an estimate of the health state of the component. However, these conventional systems encounter the same difficulties described above, i.e., the conventional systems do not take into account non-observable damage to the component and the data indicating the current state of the component is limited to available data that is often sparse.

What is needed then are systems and methods for hybrid prognostics that are described herein.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure includes a system for determining a health state of a component. The system may include a processor. The system may include a non-transitory computer-readable storage medium that may store a plurality of computer-executable instructions thereon. The processor, in response to executing the plurality of computer-readable instructions, may be configured to perform one or more steps. The steps may include obtaining, from a first data source, usage data for the component. The steps may include obtaining, from a second data source, a condition indicator for the component. The steps may include running a usage model to produce usage parameters for the component based on the usage data. The steps may include running a damage model to produce a damage estimate for the component based on the usage parameters. The steps may include running a prediction model to produce a health state estimate of the component based on the damage estimate and the condition indicator.

One aspect of the disclosure is a method of determining a health state of a component. The method may include obtaining, from a first data source, usage data for the component. The method may include obtaining, from a second data source, a condition indicator for the component. The method may include running a usage model to produce usage parameters for the component based on the usage data. The method may include running a damage model to produce a damage estimate for the component based on the usage parameters. The method may include running a prediction model to produce a health state estimate of the component based on the damage estimate and the condition indicator.

Another aspect of the disclosure is another method of determining a health state of a component. The method may include obtaining, from a first data source, usage data for the component. The method may include obtaining, from a second data source, a condition indicator for the component. The method may include running a usage model to produce usage parameters for the component based on the usage data. The method may include obtaining an assumed usage profile for the component. The method may include running a first physics-based model using the assumed usage profile and the usage data to produce a damage estimate. The method may include running a second physics-based model using the damage estimate and one or more seeded virtual faults to produce the likelihood of the condition indicator given the damage estimate, p(CI|damage). The method may include calculating a prior of the damage estimate, p(damage), based on the damage estimate. The method may include calculating an evidence of the condition indicator, p(CI), based on the condition indicator. The method may include running a Bayesian model to produce a probability of the damage estimate given the condition indicator, p(damage|CI), according to the equation:

$$p ( damage \vert CI ) = \frac{p ( CI \vert damage ) p ( damage )}{p ( CI )} .$$

Numerous other objects, advantages and features of the present disclosure will be readily apparent to those of skill in the art upon a review of the following drawings and description of various embodiments.

The systems and methods disclosed herein overcome the problems with prior art component predictive health systems, and, thus, improve the functioning of a computer and provide improvements to the technical field of mechanical systems maintenance. First, the systems and methods disclosed herein use physics-based or machine learning predictive models to estimate damage to the component that is not observable. Using data derived from non-observable damage estimates cause the systems and methods to be more accurate and to arrive at the more accurate health state estimate faster and more efficiently. Second, the systems and methods disclosed herein generate new data, i.e., health state estimates based on unobservable damage, which was not possible with conventional systems. Third, with the more accurate health state estimates generated by the present systems and methods, an operator of an apparatus can replace a component of the apparatus before the component fails, even if such failure would not be predicted by conventional systems because the failure is caused by unobservable damage.

### BRIEF DESCRIPTION OF THE DRAWINGS

FIG. 1 is a schematic block diagram illustrating one embodiment of a system for determining a health state of a component.

FIG. 2 is a flowchart diagram illustrating one embodiment of a method for determining a health state of a component that is implemented by one or more elements of the system of FIG. 1.

FIG. 3 is a flowchart diagram illustrating one embodiment of data flow during the method depicted in FIG. 2.

FIG. 4 is a flowchart diagram illustrating one embodiment of data flow during steps 202 or 206 of the method depicted in FIG. 2.

FIG. 5 is a flowchart diagram illustrating one embodiment of data flow during the method depicted in FIG. 2 where the prediction model includes a Bayesian model.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The software platform may include one or more data storages. The software platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

As used herein, the term “data object” may include a logical container for data. A data object may include an instance of an object in a software application implemented with an object-oriented programming language. A data object may include data formatted in an electronic data interchange (EDI) format, such as an eXtensible Markup Language (XML) object, a JavaScript Object Notation (JSON) object, or some other EDI-formatted object. A data object may include one or more functions that may manipulate the data of the data object. For example, a data object may include the functions or methods of an object in a software application implemented with an object-oriented programming language.

As an overview, an apparatus (e.g., a drivetrain of a multi-engine rotorcraft) may include one or more components (e.g., a gear). A component may include a health state. The health state may reflect the condition of the component. The condition may be relative to the component's ability to perform a function or exist in an environment. The component may degrade over time, which may alter the component's health state. The degradation may include degradation that is not directly observable (e.g., an internal fracture that cannot be visually observed). Once the component's health state reaches a certain point or condition, the component should be repaired or replaced. Failing to do so may result in component failure, which may damage other components of the apparatus or may result in prolonged downtime for the apparatus. Being able to determine the health state of the component is advantageous. Thus, disclosed herein are systems and methods that determine an estimate of the health state of the component, or, in other words, a health state estimate.

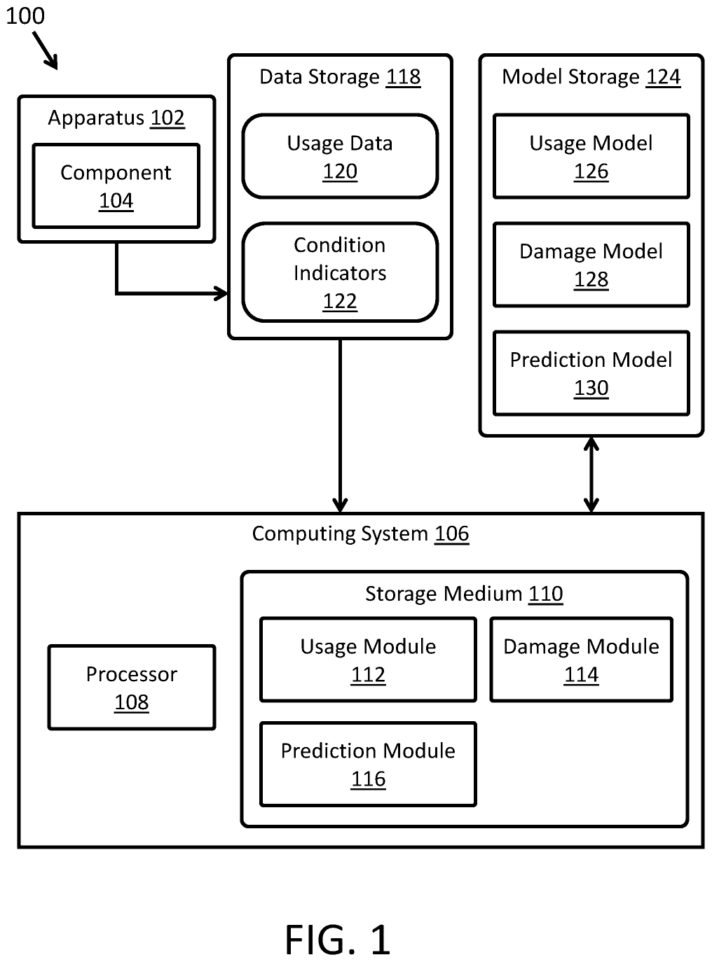

FIG. 1 depicts one embodiment of a system 100. The system 100 may include a system for hybrid prognostics. The system 100 may include an apparatus 102. The apparatus 102 may include a component 104. The component 104 may include the component for which the disclosed systems and methods determine a health state estimate. The system 100 may include a computing system 106. The computing system 106 may include a processor 108 and a computer-readable storage medium 110. The storage medium 110 may include a usage module 112, a damage module 114, or a prediction module 116. The processor 108 may execute one or more of the modules 112-116 in order to determine the health state estimate of the component 104.

The system 100 may include a data storage 118. The data storage 118 may receive usage data 120 or condition indicators 122 from the apparatus 102. The usage data 120 or condition indicators 122 may include data that may provide information about the health state of the component 104. The data storage 118 may store these usage data 120 or condition indicators 122.

The system 100 may include a model storage 124. The model storage 124 may include a usage model 126, a damage model 128, or a prediction model 130. One or more of the models 126-130 may include modeling or simulation features that may assist in determining the health state estimate of the component 104. In some embodiments, the modules 112-116 may use the models 126-130 to make determinations about the component. A model 126-130 may include physics-based model, a machine learning model, or some other type of model.

Further details regarding the system 100 are now disclosed. In one embodiment, the apparatus 102 may include a wide variety of apparatuses, devices, machines, or other apparatuses. For example, the apparatus 102 may include rotorcraft such as a helicopter. However, the apparatus 102 may include other types of machines. In one embodiment, the component 104 may include a component of the apparatus 102. The component 104 may include a physical component used in a mechanical application. The component 104 may include a bearing. The component 104 may include a gear. The component 104 may include a shaft, axle, solenoid, or other component. The component 104 may include an electrical or an electronic component. The component 104 may include some other type of component. The component 104 may include a component manufactured using a molding, machining, or casting process. The component 104 may include a component manufactured using an additive manufacturing (AM) process. As an example, in the example where the apparatus 102 includes a rotorcraft, the component 104 may include a driveshaft of the rotorcraft.

In one embodiment, the computing system 106 may include one or more computing devices. The computing system 106 may include a computing platform. The processor 108 may include one or more computer processors. A computer processor may include a central processing unit (CPU), a core of a CPU, a graphics processing unit, (GPU), or some other type of processor. The storage medium 110 may include one or more non-transitory computer-readable storage media. The storage medium 110 may include a file system, database, or other data storage. The storage medium 110 may store the one or more modules 112-116. Further details about the one or more modules 112-116 are discussed further below.

The data storage 118 may include a computer-readable storage medium. In some embodiments, the storage medium 110 may include the data storage 118. In one or more embodiments, as is shown in FIG. 1, the data storage 118 may be external to the computing system 106 but may be in data communication with the computing system 106 over a data network. For example, the data storage 118 may include a database that is external from the computing system 106, and the computing system 106 may be in data communication with the data storage 118 over the Internet.

In one embodiment, the usage data 120 may include data that describes usage of the apparatus 102 or component 104. For example, the usage data 120 may include speed values, torque values, temperature values, axial load values, radial load values, or bending moment values. In some embodiments, the condition indicators 122 may include data or a measurement that may indicate a condition of the apparatus 102 or the component 104. For example, a condition indicator 122 may include a peak value of the vibration spectrum of the component 104, a total energy contained in the vibration spectrum, or some other data or measurement. A condition indicator 122 may indicate fatigue or damage of the component 104, even if that fatigue or damage is not visible.

In one embodiment, the data storage 118 may receive data from the apparatus 102. For example, the apparatus 102 may include one or more sensors; the sensors may record data about the apparatus's 102 usage, component 104, or other data regarding the operation of the apparatus 102 or component 104; and the sensors may send the data to the data storage 118 (e.g., the sensors may automatically send the data to the data storage or an operator may retrieve the data from the sensors and upload the data to the data storage 118). In some embodiments, data about the operation of the apparatus 102 or component 104 may be recorded externally from the apparatus 102 (e.g., in the form of a flight record), and the data may be stored in the data storage 118.

In one embodiment, the model storage 124 may include a computer-readable storage medium. Similar to the data storage 118, the model storage 124 may be part of the storage medium 110 or may be external to the computing system 106. The model storage 124 may store various types of models 126-130. In one embodiment, the usage model 126 may include a model configured to receive usage data 120 associated with the apparatus 102 or component 104, process the usage data 120 to determine which usage data 120 is useful for determining the health state estimate, and output usage parameters. The damage model 128 may include a model configured to receive usage parameters or other data regarding the apparatus 102 or the component 104 and calculate and output a damage estimate. The prediction module 130 may include a model configured to receive the damage estimate or other data associated with the apparatus 102 or component 104 and determine the health state estimate for the component 104.

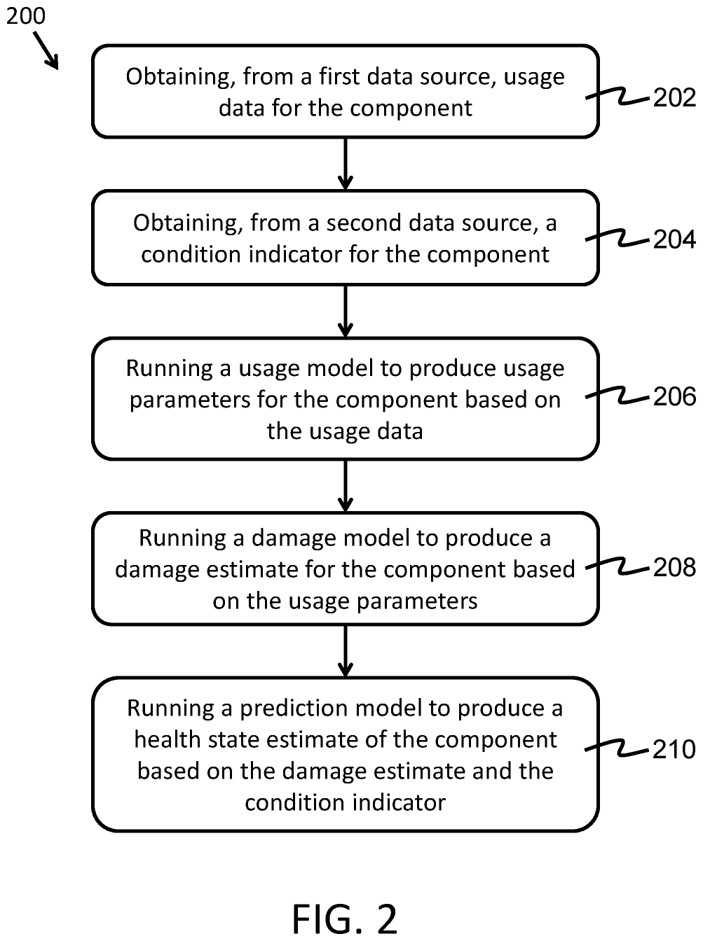

FIG. 2 depicts one embodiment of a method 200. The method 200 may include a method of determining a health state of a component 104. The method 200 may include obtaining, from a first data source, usage data 120 for the component 104 (step 202). The method 200 may include obtaining, from a second data source, a condition indicator 122 for the component 104 (step 204). The method 200 may include running a usage model 126 to produce usage parameters for the component 104 based on the usage data 120 (step 206). The method 200 may include running a damage model 128 to produce a damage estimate for the component 104 based on the usage parameters (step 208). The method 200 may include running a prediction model 130 to produce a health state estimate of the component 104 based on the damage estimate and the condition indicator 122 (step 210). The health state estimate may inform the operator of the apparatus 102 that includes the component 104 of the health state of the component 104. The operator may use this health state to determine when the component 104 may need to be repaired or replaced. In some embodiments, one or more elements of the system 100 of FIG. 1 may perform all or a portion of a step of the method 200.

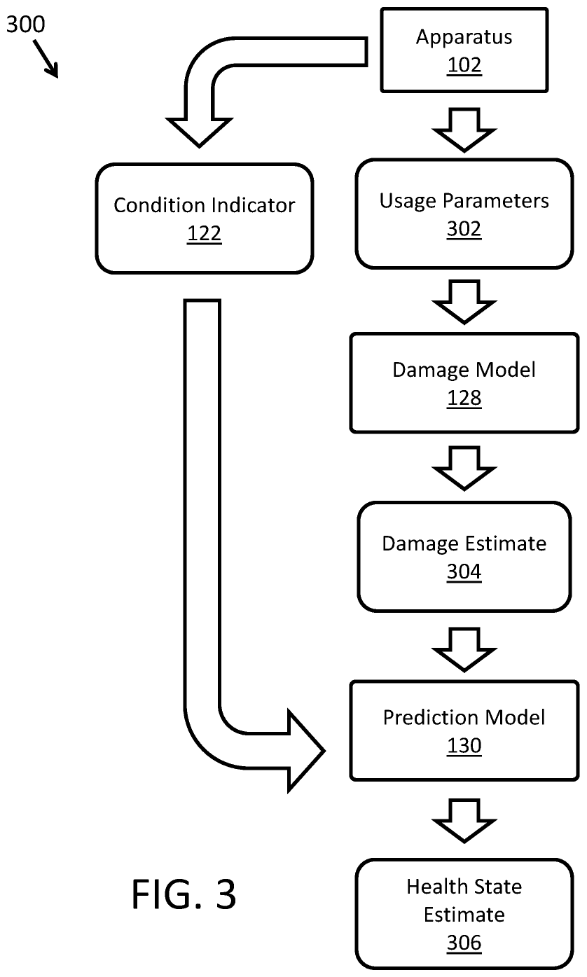

FIG. 3 depicts one embodiment of a flow 300 of data during the method 200. The flow 300 may include the apparatus 102 that may house the component 104. A condition indicator 122 and usage parameters 302 for the component 104 may be obtained from the apparatus 102 (e.g., as part of steps 202, 204, or 206 of the method 200). In one embodiment, the usage module 112 may receive the usage data 120 or the condition indicator 122 from the data storage 118. The usage module 112 may run the usage model 126 using the usage data 120 as input in order to generate the usage parameters 302. The usage module 112 may send the usage parameters 302 to the damage module 114. The damage module 114 may cause the damage model 128 to receive the usage parameters 302. The damage model 128 may accept the usage parameters 302 as input and produce a damage estimate 304 (e.g., as part of step 208). The prediction module 116 may cause the prediction model 130 to receive the damage estimate 304. The prediction model 130 may accept the damage estimate 304 and the condition indicator 122 as input and produce a health state estimate 306 (e.g., as part of the step 210).

Further information about the method 200 and portions of the flow 300 are now disclosed. In some embodiments, the health state estimate 306 of the component 104 may include a quantifiable measurement. The health state estimate 306 may include a level of pitting of the component 104, a length of a crack on the component 104, an amount of wear of the component 104, or an amount of corrosion on the component 104. The health state estimate 306 may include some other characteristic of a component 104 experiencing degradation or damage. The health state estimate 306 may include some other quantifiable measurement of the component 104. In some embodiments, the health state estimate 306 may include a measurement such as a remaining useful life (e.g., measured in a time value or a number of cycles). The health state estimate 306 may be reflected in some other way.

As stated above, the method 200 for determining the health state of the component 104 may include obtaining, from a first data source, usage data 120 for the component 104 (step 202). In some embodiments, the first data source may include an operational history of the component 104. The operational history of the component may include data about how the component 104 has operated. For example, an operational history of a gear may include the number of rotations the gear has made, when those rotations were made, a maximum rotational speed of the gear, or other measurements. The usage data 102 for the component 104 may include these measurements. The operational history of the component 104 may be based on sensor data. For example, a sensor mounted on the gear may record the number of rotations of the gear. In some embodiments, the usage data 120 may include loading conditions. A loading condition may include data about a force exerted on the component 104 during use. For example, if the component 104 includes a gear, a loading condition may include a rotational force, a torque, or a force exerted on the gear by a second gear that contacts the gear during use.f

However, having a sensor measure data about the component directly may not be feasible (e.g., the apparatus 102 may not have sufficient space for the sensor). In such a case, the first data source may include an operational history of the apparatus 102 that houses the component 104. For example, if the apparatus 102 includes a rotorcraft, then then the first data source may include a flight record of the rotorcraft. The flight record may include data that may be able to indicate how a gear of the rotorcraft operated during the flight, even though the operation of the gear was not directly measured. The usage data 120 may include the fight record data or data derived from the flight record data. In some embodiments, the first data source may include one or more sensors that may measure characteristics or movement of the apparatus 102 or the component 104. In some embodiments, the first data source may be stored in the data storage 118.

In some embodiments, the method 200 may include obtaining, from a second data source, a condition indicator 122 for the component (step 204). The second data source may include one or more of a variety of sources of data. In one embodiment, the second data source may include a sensor. The sensor may be associated with the component or the apparatus 102 housing the component 104. For example, the second data source may include an accelerometer attached to the housing of the gearbox that includes the component 104. In another embodiment, the second data source may include a health and usage monitoring system (HUMS) of the rotorcraft that includes the component 104. The second data source may include other sensors or devices that may generate, measure, or otherwise obtain a condition indicator 122 for the component 104. The second data source may be stored in the data storage 118.

As discussed above, in some embodiments, the usage data 120 obtained for the component 104 may include little to no data measured or recorded directly from or about the component 104, and instead, may include data indirectly describing the component's 104 behavior (e.g., a flight history of the rotorcraft that includes the component 104). Thus, the method 200 may include running a usage model 126 to produce usage parameters 302 for the component 104 based on the usage data 120 (step 206). The usage parameters 302 may include an estimated usage of the component 104 that can be used in further steps of the method 100. In some embodiments, the obtained usage data 120 may be sufficient, but the usage data 120 may be run through a usage model 126 to clean the usage data 120, normalize the usage data 120, or otherwise process the usage data 120 for use in further steps of the method 100.

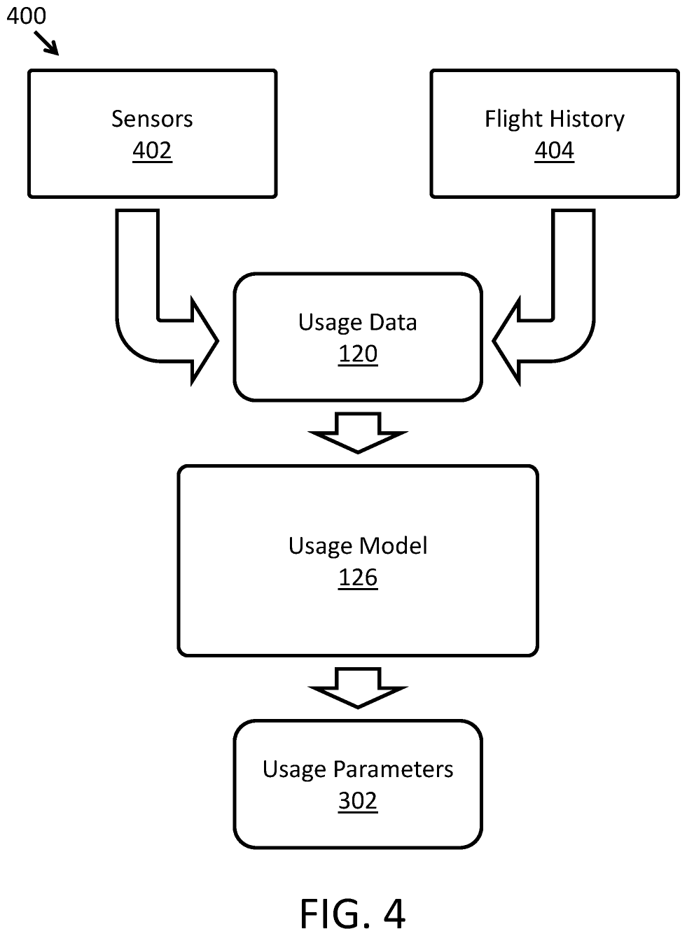

FIG. 4 depicts one embodiment of a flow 400 of data that may occur during steps 202 or 206 of the method 200. In some embodiments, one or more sensors 402 associated with the component 104 or the apparatus 102 housing the component 104 may produce the usage data 120. The apparatus 102 may produce a flight history 404, which may also form part of the usage data 120. The usage model 126 may accept, as input, at least a portion of the usage data 120. The usage model 126 may process the usage data 120 and generate, as output, usage parameters 302 for the component 104. The usage parameters 302 may include a portion of an estimated usage history of the component 104. As an example, the usage data 120 may include relevant flight physics of a rotorcraft, such as cyclic, collective, and throttle settings; air data; attitude; attitude rates; airspeed; or weight and balance information. The usage model 126 may accept the flight physics as input and may estimate the usage parameter 302 of tail rotor driveshaft torque. In some embodiments, the usage data 120 may include a time series of speed values, torque values, temperature values, axial load values, radial load values, or bending moment values. The usage parameters 302 may include a time series of speed values, torque values, temperature values, axial load values, radial load values, or bending moment values.

In one embodiment, the usage model 126 may include a physics-based model. In some embodiments, the usage model 126 may include a machine learning model. In some embodiments, the machine learning model may have been trained on a training data set that may have included training usage data (e.g., data instances similar to the usage data 120, but not identical in values to the usage data 120). Running the machine learning model may include the machine learning model performing one or more inference calculations on the usage data 120 received from the first data source.

In some embodiments, the usage model 126 may accept, as input, the condition indicator 122 obtained during step 204. In one embodiment, the usage model 126 may accept, as input, data from sensors 402 associated with the component 104 or the apparatus 102 housing the component 104 and produce, based on that input, the condition indicator 122.

The method 100 may include running a damage model 128 to produce a damage estimate 304 for the component 104 based on the usage parameters 302 (step 208 of the method 100). The damage model 128 may accept as input at least a portion of the usage parameters 302 and use them to calculate a damage estimate 304 for the component 104. The damage estimate 304 may include a quantification of the damage of the component 104. It should be noted that the term “damage,” as used herein, is not limited to physical harm caused to the component 104, for example, by another component or by an accident, but includes fatigue, degradation, wear and tear, and other similar concepts.

In one embodiment, the damage model 128 may include a physics-based model. The physics-based model may be configured to predict initiation of a crack in the component 104. In some embodiments, predicting the initiation of the crack in the component may be based on one or more parameters of the component 104 or one or more parameters associated with the component 104 or the apparatus 102. A parameter may include the usage parameters 302, a geometric parameter of the component, a material parameter of the component 104, a surface roughness parameter of the component 104, an additive manufacturing parameter for the additive manufacturing process of the component 104, a loading parameter of the component 104, or a lubricant parameter for lubrication used with the component 104. The physics-based model may be configured to simulate growth of the crack in the component 104.

In one embodiment, the geometric parameters may include geometric- or shape-related properties of at least a portion of the component 104. The geometric parameters may include part geometry of the component 104. The geometric parameters may include a size (e.g., length, width, or height; volume), shape, orientation, or location of a portion of the component 104. A portion of the component 104 may include a section, a facet, a surface, an angle, a void, an extremity, or another portion of the component 104. The geometric parameters may include a surface angle (sometimes called an “overhang angle”) of the component 104. The geometric parameters may include one or more three-dimensional computer-aided design (CAD) files or a portion of a CAD file of the component 104.

In some embodiments, the material parameters may include one or more properties of the one or more materials of which the component 104 is comprised. The material parameters may include the type of material, for example, steel, titanium, or some other metal or metal alloy. The material parameters may include a form of the material, for example, a wire, a sheet, a plate, or some other form. The material parameters may include a boiling point temperature or a melting point temperature. The material parameters may include fracture energy per unit area or facture toughness. The material parameters may include frictional stress, hardness, conductivity, heat capacity, laser absorbability, or thermal expansion. The material parameters may include elasticity, plasticity, corrosion resistance, wear resistance, density, ductility, malleability, stiffness, strength (fatigue, shear, tensile, yield, etc.). The material parameters may include other material parameters.

In one or more embodiments, the AM parameters may include properties of an AM process that may have manufactured the component 104. The AM parameters may include laser power parameters, laser scanning speed parameters (sometimes called “laser speed” or “scanning speed”), a laser scanning pattern, a laser beam shape, a laser beam size, a laser spot size, or an energy density. The AM parameters may include a powder layer thickness, hatch spacing parameters, a pre-heat temperature, or scan rotation parameters. The AM parameters may include other AM parameters.

In one embodiment, the loading parameters may include an external load applied to the component 104 as a displacement or a force. The loading parameters may include loading caused by residual stress at the end of an AM process, loading caused by residual stress resulting from heat treatment or post-processing treatment (e.g., machining). The loading parameters may include one or more forces, application angles, loading frequencies, or other parameters that may be used to calculate damage. A loading parameter may include a loading condition.

In some embodiments, running the damage model 128 (step 208) may include the damage model 128 considering the statistical nature of the surface roughness and material parameters of the component 104. This may include sampling from the probability distributions that describe these quantities to produce one or more damage estimate 304 outputs. Producing the one or more damage estimate 304 outputs may include a Monte Carlo-style method of characterizing one or more predicted early damage characteristics. The damage model 128 may propagate uncertainty in the component 104 attributes by producing a discrete set of outputs representing an empirical distribution of damage estimates 304 induced by input uncertainty. In some embodiments, the damage model 128 may include linear elastic fracture mechanics (LEFM), peridynamics, or one or more empirical models.

In some embodiments, the damage model 128 may produce a damage estimate 304 for only one set of operational conditions of the component 104 at a time. This may include the damage model 128 fitting a probability distribution to the empirical data produced by the damage model 128. The health state estimate 306 may be quantified by, for example, indicating the value of the cumulative density function corresponding to the number of loading cycles the component 104 has experienced. This number may represent the probability that damage has initiated a given a number of loading cycles. In some embodiments, the damage model 128 may consider confidence intervals fitted to the probability distribution parameters. The damage model 128 may propagate uncertainty and produce a range on the chance that damage has initiated.

The method 200 may include running a prediction model 130 to produce a health state estimate 306 of the component 104 based on the damage estimate 304 and the condition indicator 122 (step 210). In one embodiment, the prediction model 130 may include a Bayesian model. The Bayesian model may produce a probability of the damage estimate 304 given the condition indicator 122, p(damage|CI). The Bayesian model may produce p(damage|CI) according to the equation:

$$p ( damage \vert CI ) = \frac{p ( CI \vert damage ) p ( damage )}{p ( CI )}$$

where p(CI|damage) is a likelihood of the condition indicator 122 given the damage estimate 304, p(damage) is a prior of the damage estimate 304, and p(CI) is an evidence of the condition indicator 122. In some embodiments, the Bayesian model may produce a single probability output of the damage estimate 304 given the condition indicator 122, p(damage|CI). In one embodiment, the Bayesian model may produce a conditional probability distribution for a plurality of damage estimates 304 given a plurality of condition indicators 122.

In some embodiments, the damage estimate 304 of FIG. 2 may include the probability of the damage estimate 304 given the condition indicator 122, p(damage|CI). The health state estimate 306 of FIG. 3 may include the prior of the damage estimate 304, p(damage).

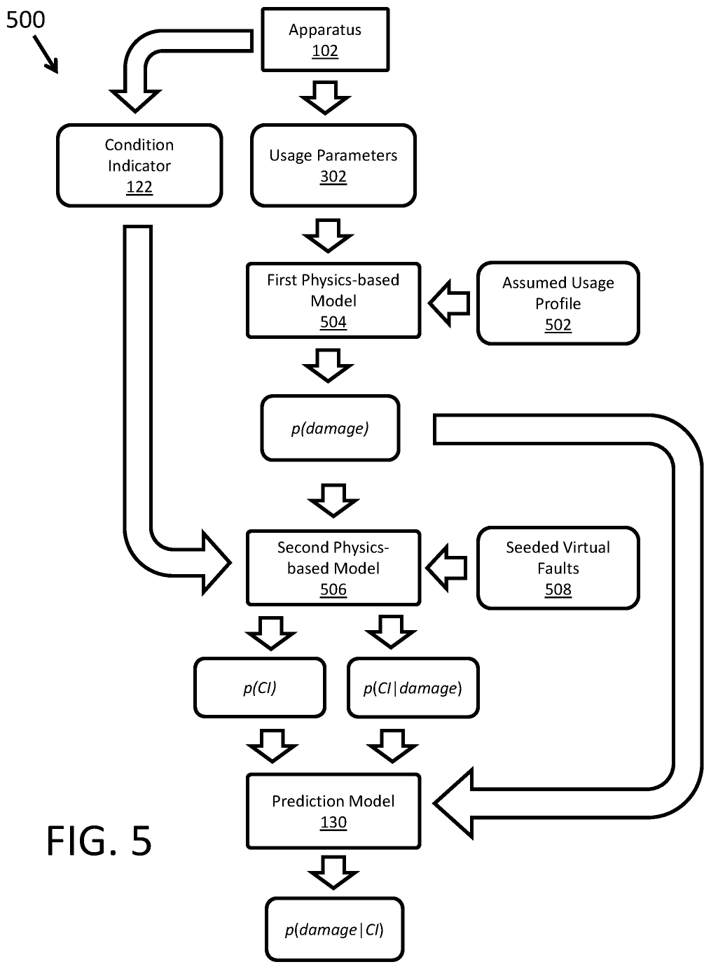

FIG. 5 depicts one embodiment of a flow 500 of data during the method 200. As can be seen from FIG. 5, the condition indicator 122 and the usage parameters 302 may be obtained from the apparatus 102. This may be part of activity discussed previously in relation to steps 202, 204, or 206 of the method 200 of FIG. 2, in relation to FIG. 3, or in relation to FIG. 4. In one embodiment, the flow 500 may include obtaining an assumed usage profile 502 for the component 104. The assumed usage profile 502 may include an operational history of the use of the component 104 or the apparatus 102. The assumed usage profile 502 may include at least a portion of the usage data 120, at least a portion of the usage parameters 302, or may include other data. The assumed usage profile 502 may include artificially created usage data, interpolated data, extrapolated data, or other data. The assumed usage profile 502 may be stored in the data storage 118.

The flow 500 may further include a first physics-based model 504. Running the first physics-based model 504 may include using the assumed usage profile 502 and the usage data 120 or the usage parameters 302 to produce a probability of the damage estimate 304, p(damage). In one embodiment, running the first physics-based model 504 may include producing an S-N curve based on the assumed usage profile 502, and using the S-N curve with Miner's rule and the usage data 120 or the usage parameters 302 to produce p(damage). In another embodiment, running the first physics-based model 504 may include running a long crack growth model to produce p(damage).

In one embodiment, running the first physics-based model 504 may include the first physics-based model 504 drawing one or more samples from probability distributions describing features about the surface and microstructure of the component 104. In this approach, the first physics-based model 504 may generate a set of samples of domains and surfaces of the component 104. The set may include fewer than 30 samples, between 30 and 100 samples, or more than 100 samples. The first physics-based model 504 may execute for each member of this set, and the inputs for each member of this collection may cover, at least in part, the expected operational conditions of the component 104. This may include manual specification of conditions or techniques such as adaptive design of experiments. In some embodiments, interpolation may be available for a dataset to assess outputs for inputs that do not correspond to the simulated conditions. The first physics-based model 504 may fit a response surface to the data points in the dataset. By doing this, the first physics-based model 504 may generate a set of response surfaces, one for each domain and surface sample. The first physics-based model 504 may use Miner's Rule with each individual response surface to produce a collection of fractions of life that may have been consumed based on the operational history. This collection may serve as an empirical distribution, which the first physics-based model 504 may fit with a parametric distribution for further analysis. In one embodiment, the first physics-based model 504 may rerun in response to encountering a new set of operational conditions that the model 504 may not have previously simulated.

In one embodiment, running the first physics-based model 504 may include the first physics-based model 504 considering variable loading of the component 104 directly. This may include the first physics-based model 504 accepting, as an input, a specific loading history. The specific loading history may include the assumed usage profile 502 or other data. The first physics-based model 504 may directly compute the results of variable loading rather than relying on aggregation through Miner's Rule. The health state, in this embodiment, may be captured as the state of the damage model 128 parameters as maintained by first physics-based model 504. In this embodiment, the first physics-based model 504 may consider a higher number of domains of the component 104. A portion of the domains many have experienced a fatigue crack, whereas others may have not. In some embodiments, the first the first physics-based model 504 may output the number of domains that have experienced failure. The first physics-based model 504 may fit a distribution accordingly, given computed failure times.

The flow 400 may include a second physics-based model 506. Running the second physics-based model 506 may include accepting the damage estimate 304 or the probability of the damage estimate 304, p(damage), one or more seeded virtual faults 508, or the condition indicator 122 as input. The second physics-based model 506 may produce a likelihood of the condition indicator 122 given the damage estimate 304, p(CI|damage). In one or more embodiments, the second physics-based model 506 may produce the evidence of the condition indicator, p(CI). The second physics-based model 506 may produce p(CI) based on the condition indicator 122. In some embodiments, some other model or system may generate p(CI).

In one or more embodiments, the first physics-based model 504 or the second physics-based model 506 may further receive one or more actual operating conditions of the component 104 as input. The one or more actual operating conditions may include the usage data 120, the usage parameters 302, or other data. The first physics-based model 504 or the second physics-based model 506 may then rerun based on the one or more actual operating conditions. In some embodiments, after running the first physics-based model 504 and the second physics-based model 506, the inputs of the Bayesian model (i.e., p(CI|damage), p(damage), and p(CI)) may be ready. In some embodiments, the prediction model 130 may generate the inputs of the Bayesian model in some other manner.

In one embodiment, running the prediction model 130 may include running a physics-based model. This may include the first physics-based model 504 or the second physics-based model 506, discussed above, or may include some other physics-based model. In one or more embodiments, running the prediction model 130 may include running a machine-learning model. In some embodiments, the damage model 128 may include the first physics-based model 504, the second physics-based model 506, some other physics-based model, or some other type of model.

In one embodiment, the method 200 may include performing direct observation on the component 104 to obtain a level of observable degradation for the component 104. Performing direct observation on the component 104 may include performing a visual inspection of the component 104. Performing direct observation on the component 104 may include performing non-destructive testing on the component 104. In some embodiments, the damage model 128 may accept the level of observable degradation as input. Running the damage model 128 (step 208) may include producing the damage estimate 304 based on the level of observable damage. In one embodiment, the prediction model 130 may accept the level of observable degradation as input. Running the prediction model 130 (step 210) may include producing the health state estimate 306 based on the level of observable damage.

In some embodiments, the system 100 may display the health state estimate 306 in a displayable form on a UI. The UI may include a UI displayed on a display device that may be part of the computing system 106 or may be in data communication with the computing system 106. The health state estimate 306, as displayed by the UI, may include a remaining useful life (RUL). The RUL may be in the form of a time value. For example, the RUL may include 46 days, which may indicate that the component 104 should be repaired or replaced within 46, and otherwise the component 104 provides an increased risk of failing. In some embodiments, the RUL may include a number of cycles of the component 104. For example, if the component 104 includes a gear, the RUL may include a number of rotations of the gear (e.g., 10,000 further rotations).

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable media. Each of the usage module 112, damage module 114, or the prediction module 116 may include a module.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The storage medium 110 may include a computer-readable storage medium. The data storage 118 may include a computer-readable storage medium. The model storage 124 may include a computer-readable storage medium.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The systems 100 and methods 200 disclosed herein overcome the problems with prior art component predictive health systems, and, thus, improve the functioning of a computer and provide improvements to the technical field of mechanical systems maintenance. First, the systems 100 and methods 200 disclosed herein use physics-based or machine learning predictive models (such as the usage model 126, damage model 128, or predictive model 130) to estimate damage to the component 104 that is not observable. Using data derived from non-observable damage estimates (such as the usage parameters 302, the assumed usage profile 502, or the seeded virtual faults 508) cause the systems 100 and methods 200 to be more accurate and to arrive at a more accurate health state estimate 306 faster and more efficiently. Second, the systems 100 and methods 200 disclosed herein generate new data, i.e., health state estimates 306 based on unobservable damage or sparse usage data 120 or condition indicators 122, which was not possible with conventional systems. Third, with the more accurate health state estimates 306 generated by the present systems 100 and methods 200, an operator of an apparatus 102 can replace a component 104 of the apparatus 102 before the component 104 fails, even if such failure would not be predicted by conventional systems because the failure is caused by unobservable damage or because insufficient data was available to generate a useful health state estimate.

Thus, although there have been described particular embodiments of the present disclosure of a new and useful systems and methods for hybrid prognostics, it is not intended that such references be construed as limitations upon the scope of this disclosure. For example, it should be noted that while the above disclosure discusses certain models performing certain actions or method steps, other models may perform those actions or steps.

What is claimed is:

1. A system for determining a health state of a component, comprising:
a processor; and
a non-transitory computer-readable storage medium storing a plurality of computer-executable instructions thereon, wherein the processor, in response to executing the plurality of computer-readable instructions, is configured to
obtain, from a first data source, usage data for the component,
obtain, from a second data source, a condition indicator for the component,
run a usage model to produce usage parameters for the component based on the usage data,
run a damage model to produce a damage estimate for the component based on the usage parameters, and
run a prediction model to produce a health state estimate of the component based on the damage estimate and the condition indicator.

2. The system of claim 1, wherein the first data source comprises a flight record.

3. The system of claim 1, wherein the second data source comprises at least one of:
an accelerometer; or
a health and usage monitoring system (HUMS).

4. The system of claim 1, wherein the usage data comprises a time series of at least one of:
speed values;
torque values;
temperature values;
axial load values;
radial load values; or
bending moment values.

5. The system of claim 1, wherein the usage parameters comprise a time series of at least one of:
speed values;
torque values;
temperature values;
axial load values;
radial load values; or
bending moment values.

6. The system of claim 1, wherein the processor being configured to run the damage model comprises the processor being configured to run a physics-based model that is configured to:
predict initiation of a crack in the component; and
simulate growth of the crack in the component.

7. The method of claim 6, wherein the physics model being configured to predict the initiation of the crack in the component is based on at least one of:
a geometric parameter of the component;
a material parameter of the component;
a surface roughness parameter of the component;
an additive manufacturing parameter for the additive manufacturing process of the component;
a loading parameter of the component; or
a lubricant parameter for lubrication used with the component.

8. A method of determining a health state of a component, the method comprising:
obtaining, from a first data source, usage data for the component;
obtaining, from a second data source, a condition indicator for the component;
running a usage model to produce usage parameters for the component based on the usage data;
running a damage model to produce a damage estimate for the component based on the usage parameters; and
running a prediction model to produce a health state estimate of the component based on the damage estimate and the condition indicator.

9. The method of claim 8, wherein running the usage model comprises running a physics-based model.

10. The method of claim 8, wherein running the usage model comprises running a machine learning model.

11. The method of claim 10:
further comprising:
generating training data based on a second set of usage data, and
training the machine learning model on the training data; and
wherein running the machine learning model includes the machine learning model performing one or more inference calculations on the usage data.

12. The method of claim 8, wherein running the prediction model comprises running a Bayesian model to produce a probability of the damage estimate given the condition indicator.

13. The method of claim 12, wherein:
the Bayesian model produces the probability of the damage estimate given the condition indicator, p(damage|CI), according to the equation
$$p ( damage \vert CI ) = \frac{p ( CI \vert damage ) p ( damage )}{p ( CI )} ;$$
p(CI|damage) is a likelihood of the condition indicator given the damage estimate;
p(damage) is a prior of the damage estimate; and
p(CI) is an evidence of the condition indicator.

14. The method of claim 13:
further comprising obtaining an assumed usage profile for the component; and
wherein running the damage model comprises
running a first physics-based model using the assumed usage profile and the usage data to produce the damage estimate, and
running a second physics-based model using the damage estimate and one or more seeded virtual faults to produce the likelihood of the condition indicator given the damage estimate, p(CI|damage).

15. The method of claim 14, wherein running the first physics-based model comprises at least one of:
producing an S-N curve based on the assumed usage profile, and using the S-N curve with Miner's rule and the usage data to produce the damage estimate; or
running a long crack growth model to produce the damage estimate.

16. The method of claim 14, further comprising:
obtaining one or more actual operating conditions of the component; and
rerunning at least one of the first physics-based model or the second physics-based model based on the one or more actual operating conditions.

17. The method of claim 13, wherein running the Bayesian model comprises producing a conditional probability distribution for a plurality of damage estimates given a plurality of condition indicators.

18. The method of claim 8:
further comprising performing direct observation on the component to obtain a level of observable degradation for the component; and
wherein running the damage model is further based on the level of observable damage.

19. The method of claim 8, wherein the health state of the component comprises at least one of:
a level of pitting of the component;
a length of a crack on the component;
an amount of wear of the component; or
an amount of corrosion on the component.

20. A method of determining a health state of a component, the method comprising:
obtaining, from a first data source, usage data for the component;
obtaining, from a second data source, a condition indicator for the component;
running a usage model to produce usage parameters for the component based on the usage data;
obtaining an assumed usage profile for the component;
running a first physics-based model using the assumed usage profile and the usage data to produce a damage estimate;
running a second physics-based model using the damage estimate and one or more seeded virtual faults to produce the likelihood of the condition indicator given the damage estimate, p(CI|damage);
calculating a prior of the damage estimate, p(damage), based on the damage estimate;
calculating an evidence of the condition indicator, p(CI), based on the condition indicator;
running a Bayesian model to produce a probability of the damage estimate given the condition indicator, p(damage|CI), according to the equation
$$p ( damage \vert CI ) = \frac{p ( CI \vert damage ) p ( damage )}{p ( CI )} .$$
